(19) United States
(12) Patent Application Publication
(10) Pub. No.: US 2007/0202291 A1
(43) Pub. Date: Aug. 30, 2007

(54) Optical recording medium

(75) Inventors: Koji Mishima, Tokyo (JP); Daisuke Yoshitoku, Tokyo (JP); Kazushi Tanaka, Tokyo (JP)

Correspondence Address: OLIFF & BERRIDGE, PLC, P.O. BOX 19928, ALEXANDRIA, VA, 22320, US

(73) Assignee: TDK CORPORATION, TOKYO (JP)

(21) Appl. No.: 11/709,687

(22) Filed: Feb. 23, 2007

(30) Foreign Application Priority Data
Feb. 27, 2006 (JP) 2006-050769

(51) Int. Cl. B32B 3/02

(52) U.S. Cl. 428/64.4

(57) ABSTRACT

An optical recording medium is provided which includes a plurality of information layers having recording sensitivities close to each other and reflectivities close to each other, and a sufficient difference in reflectivity between a space portion and a recording mark, and provides a reduction in production costs. The optical recording medium includes a first and a second information layer. Recording marks thicker than a space portion are formed in the information layers. The recording layer of the first information layer which is placed far from an incident surface is thicker than the recording layer of the second information layer which is placed close to the incident surface. The total thickness of dielectric layers of the first information layer is smaller than the total thickness of dielectric layers of the second information layer. The first information layer is thinner than the second information layer.

### BACKGROUND OF THE INVENTION

1. Field of the Invention

The present invention relates to an optical recording medium having a plurality of recording layers.

2. Description of the Related Art

Optical recording media such as compact discs (CDs) and digital versatile discs (DVDs) are widely utilized as information recording media. In particular, some types of optical recording media which utilize a blue or blue-violet laser as the irradiation light to allow for the recording of far more information than conventional lasers are becoming popular.

The optical recording media are generally classified into three types: a read-only memory (ROM) type, which can neither record nor rewrite data, a rewritable (RW) type, which can rewrite data, and a recordable (R) type, which can record data only once.

In the R-type optical recording media, a laser beam, when being irradiated onto a portion of a recording layer, increases or decreases reflectivity of that portion as compared with that of the space portions therearound, thereby allowing for the recording of data. The portion, of which reflectivity is increased or decreased, is referred to as a recording mark. Incidentally, the recording laser beam is irradiated onto not only the recording mark but also the space portion close to the recording mark. However, light that is irradiated onto the space portion is very weak and thus the reflectivity of the space portion is kept almost equal to that of the recording layer before irradiation. The data recorded on the R-type optical recording medium is reproduced in such a manner that the recording layer is irradiated with a laser beam, and a photodetector then measures the difference in reflectivity between the recording mark and the space portion.

Such optical recording media can have an increased storage capacity if a plurality of recording layers is provided. For example, in R-type optical recording media that have a plurality of recording layers, data can be selectively recorded on a target recording layer by focusing a recording laser beam onto the target recording layer. Furthermore, the data can be selectively reproduced from that target recording layer by focusing a reproducing laser beam onto the layer.

It is preferable for the R-type optical recording medium having a plurality of recording layers that each recording layer is irradiated with a recording laser beam at the same power so that the same good quality recording marks are formed on each recording layer. It is also preferable that each recording layer is irradiated with the reproducing laser beam at the same power so that the intensity of the reflected light from each recording layer is measured by a photodetector to be substantially equal.

However, the lower recording layer, which is placed relatively far from the incident surface, is irradiated with a laser beam that has passed through the upper recording layer, which is placed closer to the incident surface than the lower recording layer. The laser beam is, therefore, partially absorbed by the upper recording layer. Moreover, the reflected light of the laser beam from the lower recording layer is also partially absorbed by the upper recording layer, since the reflected light enters the photodetector through the upper recording layer.

Accordingly, when a recording laser beam with the same power level is irradiated onto each of the lower and upper recording layers, and when the lower and upper recording layers have the same recording sensitivity by themselves, the power of the recording laser beam at the lower recording layer may be insufficient to form a good quality recording mark in the lower recording layer.

Moreover, if a reproducing laser beam with the same power level is irradiated onto each of the lower and upper recording layers, and if the lower recording layer has the same reflectivity as the upper recording layer by itself, the reflectivity of the lower recording layer will be measured by the photodetector to be a value smaller than that of the upper recording layer.

R-type optical recording media that have recording layers in which the lower layer is thicker than the upper layer are known (for example, see Japanese Patent Laid-open Publication No. 2003-266936). The thicker lower recording layer absorbs an increased amount of energy from the laser beam.

This technique allows the formation of good quality recording marks on both the upper and lower recording layers.

Furthermore, the structure where the lower recording layer being thicker than the upper recording layer has the advantage of making the reflectivity of the lower recording layer closer to the reflectivity of the upper recording layer, as will be described below.

FIG. 6 is a graph showing the relationship between the thickness and the reflectivity of a single recording layer having a refractive index of 2.45. In FIG. 6, the curve S represents the reflectivity of the space portion of the recording layer, and the curve M represents the reflectivity of the recording mark of the recording layer.

The curve S shows that a specific thickness gives the maximum reflectivity to the space portion of the recording layer, and that thicknesses greater or less than that specific thickness give lower reflectivities to the space portion. Likewise, the curve M shows that almost the specific thickness gives the maximum reflectivity to the recording mark of the recording layer, and that thicknesses greater or less than that specific thickness give lower reflectivities to the recording mark. The maximum difference in reflectivity between the space portion and the recording mark occurs at a thickness giving almost their respective maximum reflectivities. Thicknesses greater or less than this thickness give smaller differences in reflectivity. Accordingly, recording layers that are too thick or too thin have a very small difference in reflectivity, so that it is hard to read the recording marks. Incidentally, large differences in reflectivity is obtained in relatively wide range of thickness when the thickness is smaller than the thickness that gives almost maximum reflectivities of the space portion and recording mark. By contrast, large differences in reflectivity is obtained in relatively narrow range of thickness when the thickness is larger than the thickness that gives almost maximum reflectivities of the space and recording mark.

Therefore, if the recording layers are formed so that the lower layer has a thickness giving the maximum reflectivity and the upper layer is thinner than the lower layer, the reflectivity of the single lower recording layer will be higher than that of the upper recording layer. Accordingly, it is possible to make the reflectivity of the lower recording layer close to the reflectivity of the upper recording layer even when the reproducing laser beam that is to be irradiated onto the lower recording layer is partially absorbed by the upper recording layer before entering the photodetector. Furthermore, in view of the large difference in reflectivity between the recording mark and the space portion, it is preferable to form the lower and upper recording layers with each having a thickness not larger than the thickness that gives the maximum reflectivity.

However, it is difficult to provide sufficient difference in reflectivity between the recording mark and the space in conventional recording layers made of an organic dye or inorganic material, when a blue or blue-violet laser beam is used as the irradiation light, even if the lower recording layer with a thickness that gives the maximum reflectivity and the upper recording layer being thinner than the lower recording layer are formed.

In view of the foregoing, the inventors have tried to form recording layers with various materials to develop the present invention. As a result, it has been found that a recording layer containing bismuth and oxygen gives sufficient difference in reflectivity between the recording mark and the space portion even when a blue or blue-violet laser beam is used as the irradiation light. Specifically, sufficient difference in reflectivity between the recording mark and the space portion occurs when the ratio of the total number of bismuth and oxygen atoms to the number of constituent atoms in the recording layer is 80% or more, and the ratio of the number of oxygen atoms to the number of constituent atoms in the recording layer is 63% or more. It has also been found that this recording layer has a smaller extinction coefficient than conventional recording layers.

A recording mark thicker than a space portion therearound is formed when the recording layer is irradiated with the blue or blue-violet laser beam.

The reflectivity of the recording mark, which is thicker than the space portion, is equal to the reflectivity of the recording mark of a recording layer, shown by the curve M in FIG. 6, which has the same thickness as the thicker recording mark. In other words, the relationship between the thickness of the recording layer and the reflectivity of the recording mark is shown by a curve obtained by shifting the curve M to a smaller thickness by the increased amount in the thickness of the recording mark, as shown in FIG. 1. This results in a significant increase in the difference in reflectivity between the space portion and the recording mark.

Furthermore, the lower recording layer, which is made thicker than the upper recording layer, absorbs an increased amount of energy from the laser beam, allowing the formation of good quality recording marks in both the lower and upper recording layers.

However, as shown in FIG. 1, in the range of significant difference in reflectivity between the space portion and the recording mark, the thicker the recording layer, the less the reflectivity. Accordingly, if the lower recording layer is made thicker than the upper recording layer, the reflectivity of the lower recording layer by itself will be lower than that of the upper recording layer. This causes a problem in that the reflectivity of the lower recording layer is measured by the photodetector to be a significantly lower value than that of the upper recording layer.

Even in this case, if the lower recording layer is formed with a material that is different from that of the upper recording layer so that good quality recording marks are formed by a recording laser beam having a lower power than used for the upper recording layer, and if the lower recording layer is made thinner than the upper recording layer, the recording sensitivities of both layers can be close to each other, and the reflectivities of these layers when measured by the photodetector can be close to each other.

However, to form a plurality of recording layers, each of which is made of a different material, in a vacuum deposition device, different targets are required for the different respective recording layer materials. Besides, to form a plurality of recording layers, each of which is made of a different material, by only one vacuum deposition device, replacement of the target for each recording layer will be required. Alternatively, to form a plurality of recording layers, each of which is made of a different material, without replacement of the target, two or more vacuum deposition devices are required. This causes an increase in production costs.

If a reflective layer is provided under the lower recording layer to increase the reflectivity of the lower recording layer, the reflective layer allows the upper recording layer to be thicker depending on the increase in the level of reflectivity it provides. However, the formation of the reflective layer also causes an increase in production costs.

### SUMMARY OF THE INVENTION

In view of the foregoing problems, various exemplary embodiments of this invention provide an optical recording medium having a plurality of information layers, whose recording sensitivities are close to each other and whose reflectivities are close to each other, having a sufficient difference in reflectivity between the space portion and recording marks formed, and providing a reduction in production costs.

In order to achieve the objects, various exemplary embodiments of this invention provide an optical recording medium having a plurality of information layers and no reflective layer on at least one side, the information layers on which a recording mark, having an increased thickness larger than that of a space portion therearound, is formed by an irradiation with a laser beam. At least two of the information layers each have a recording layer and a dielectric layer which is formed on at least one side of the recording layer. One of the information layers, which is placed relatively far from an incident surface of a laser beam, has a recording layer that is thicker than that of the other of the information layers, which is placed relatively closer to the incident surface than the one information layer. The one information layer also has a dielectric layer that is thinner than that of the other information layer. The total thickness of the recording layer and the dielectric layer of the one information layer is smaller than that of the other information layer.

Alternatively, in order to achieve the objects, various exemplary embodiments of this invention provide an optical recording medium having a plurality of information layers on at least one side, the information layers on which a recording mark, having an increased thickness larger than a space portion therearound is formed by an irradiation with a laser beam. At least two of the information layers each have a recording layer and a dielectric layer which is formed on at least one side of the recording layer. The recording layers each contain a constituent element other than carbon, oxygen, nitrogen, hydrogen, and sulfur. Constituent elements of the recording layers, at least other than carbon, oxygen, nitrogen, hydrogen, and sulfur, are common. One of the information layers, which is placed relatively far from an incident surface of a laser beam, has a recording layer that is thicker than that of the other of the information layers, which is placed relatively closer to the incident surface than the one information layer. The one information layer also has a dielectric layer that is thinner than that of the other information layer. The total thickness of the recording layer and the dielectric layer of the one information layer is smaller than that of the other information layer.

In the optical recording medium, since the lower (far from an incident surface of a laser beam) information layer has a thicker recording layer than that of the upper (closer to the incident surface) information layer, the lower information layer can absorb an increased amount of energy from the laser beam, making recording sensitivities of these information layers close to each other.

Since the refractive index of the dielectric layer is close to the refractive index of the recording layer, the reflectivity of the information layer is not equal to the reflectivity of the single recording layer, but is close to the reflectivity of the single recording layer that is made thicker by the thickness of the dielectric layer.

Accordingly, even if the recording layer of the lower information layer is made thicker than that of the upper information layer, when the lower information layer, which is composed of the recording layer and the dielectric layer, is made thinner than the upper information layer also composed of the recording layer and the dielectric layer, the lower information layer can have a larger reflectivity than that of the upper information layer, so that the reflectivities of these information layers measured by a photodetector are close to each other.

Moreover, this layer structure provides the lower information layer with a high reflectivity that is sufficient for the photodetector to detect, without a reflective layer provided under the lower information layer. Such an optical recording medium having no reflective layer provides a reduction in production costs required to produce the reflective layer.

Furthermore, the recording layers of the plurality of information layers, each of which contains common constituent elements at least other than carbon, oxygen, nitrogen, hydrogen, and sulfur, can therefore be formed using the same target in a single deposition device. An optical recording medium that has these recording layers would therefore provide a reduction in production costs. The recording layers each may further contain at least one s of carbon, oxygen, nitrogen, hydrogen, and sulfur as a common constituent element. Alternatively, they may contain at least one of carbon, oxygen, nitrogen, hydrogen, and sulfur as a different constituent element. Carbon, oxygen, nitrogen, hydrogen, and sulfur can be provided as gas sources in a deposition device. Therefore, the recording layers that further contain at least one of these elements as a different constituent element can be also formed using the same target in the single deposition device, providing a reduction in production costs.

Accordingly, various exemplary embodiments of this invention provide an optical recording medium comprising a plurality of information layers and no reflective layer on at least one side, the information layers in which a recording mark, having an increased thickness larger than that of a space portion therearound, is formed by an irradiation with a laser beam, at least two of the information layers each having a recording layer and a dielectric layer formed on at least one side of the recording layer, one of these information layers, which is placed relatively far from an incident surface of a laser beam, having a recording layer that is thicker than that of the other of the information layers, which is placed relatively closer to the incident surface than the one information layer, the one information layer having a dielectric layer that is thinner than that of the other information layer, wherein a total thickness of the recording layer and the dielectric layer of the one information layer is smaller than that of the other information layer.

Alternatively, various exemplary embodiments of this invention provide an optical recording medium comprising a plurality of information layers on at least one side, information layers in which a recording mark, having an increased thickness larger than that of a space portion therearound, is formed by an irradiation with a laser beam, at least two of the information layers each having a recording layer and a dielectric layer formed on at least one side of the recording layer, the recording layers each containing a constituent element other than carbon, oxygen, nitrogen, hydrogen, and sulfur, and constituent elements of the recording layers, at least other than carbon, oxygen, nitrogen, hydrogen, and sulfur, are common, one of the information layers, which is placed relatively far from an incident surface of a laser beam, has a recording layer that is thicker than that of the other of the information layers, which is placed relatively closer to the incident surface than the one information layer, the one information layer having a dielectric layer that is thinner than that of the other information layer, wherein a total thickness of the recording layer and the dielectric layer of the one information layer is smaller than that of the other information layer.

Herein, the phrase “thickness of the dielectric layer of the information layer” is intended to mean, for the information layer in which a single dielectric layer is formed on only one side of the recording layer, the thickness of the single dielectric layer, and for the information layer in which two dielectric layers are formed on both sides of the recording layer, the total thickness of these two dielectric layers.

Furthermore, herein, the phrase “reflective layer” is intended to mean a metal layer, formed between a substrate and the closest information layer to the substrate, having a thickness of not less than 10 nm.

According to the present invention, it is possible to provide an optical recording medium that has a plurality of information layers whose recording sensitivities are close to each other and whose reflectivities are close to each other, where each information layer has a sufficient difference in reflectivity between the space portion and the recording mark, providing a reduction in production costs.

### BRIEF DESCRIPTION OF THE DRAWINGS

FIG. 1 is a graph showing a relationship between the thickness and the reflectivity of a recording layer of an optical recording medium according to a first exemplary embodiment of the present invention;

FIG. 2 is a schematic cross sectional view in a lengthwise direction of grooves showing a structure of information layers and therearound of the optical recording medium;

FIG. 3 is a schematic cross sectional view in a widthwise direction of grooves showing the entire structure of the optical recording medium;

FIG. 4 is a schematic cross sectional view showing a structure of information layers and therearound of an optical recording medium according to a second exemplary embodiment of the present invention;

FIG. 5 is a schematic cross sectional view showing the entire structure of the optical recording medium according to the second exemplary embodiment; and

FIG. 6 is a graph showing a relationship between the thickness and the reflectivity of a recording layer of a conventional optical recording medium.

### DETAILED DESCRIPTION OF THE PREFERRED EMBODIMENTS

Preferred exemplary embodiments of the present invention will be described in detail below with reference to the drawings.

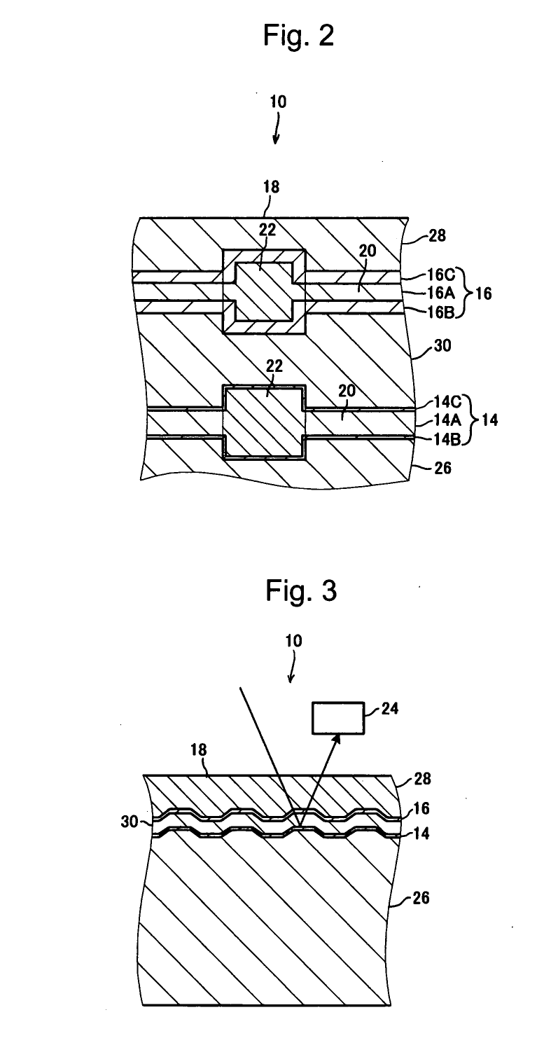

An optical recording medium 10 according to a first exemplary embodiment of the present invention is disc-shaped, having an outer diameter of approximately 120 mm and a thickness of approximately 1.2 mm. As shown in FIGS. 2 and 3, the optical recording medium 10 has a first information layer 14 and a second information layer 16 on one side of a substrate 26. In these information layers, recording marks 22, having an increased thickness larger than space portion 20 therearound, are formed by an irradiation with a laser beam. The first information layer 14 has a recording layer 14A, and dielectric layers 14B and 14C that are formed on both sides of the recording layer 14A. The second information layer 16 has a recording layer 16A, and dielectric layers 16B and 16C that are formed on both sides of the recording layer 16A. The recording layer 14A of the first information layer 14 and the recording layer 16A of the second information layer 16 contain bismuth (being a constituent element other than carbon, oxygen, nitrogen, hydrogen, and sulfur), and oxygen in common. The first information layer 14 is placed relatively far from an incident surface 18 of a laser beam. The second information layer 16 is placed relatively close to the incident surface 18. The recording layer 14A is thicker than the recording layer 16A. A total thickness of the dielectric layers 14B and 14C is smaller than a total thickness of the dielectric layers 16B and 16C. A total thickness of the recording layer 14A and the dielectric layers 14B and 14C is smaller than a total thickness of the recording layer 16A and the dielectric layers 16B and 16C.

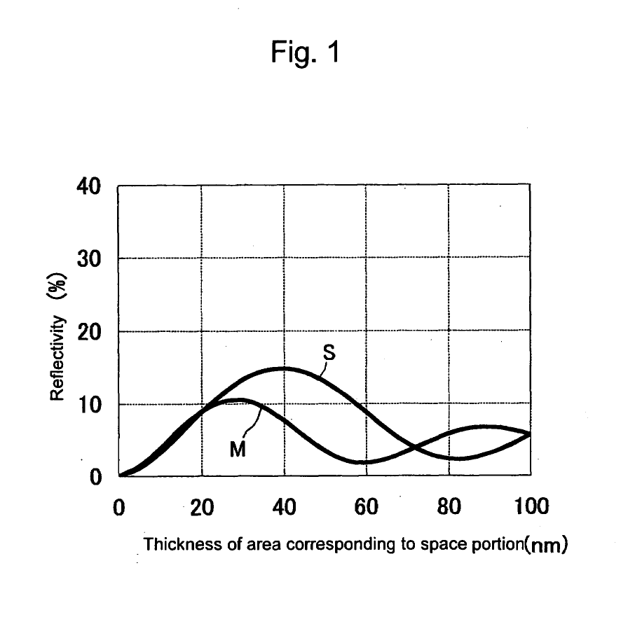

The recording layers 14A and 16A each contain bismuth and oxygen. Specifically, the ratio of the total number of bismuth and oxygen atoms to the number of constituent atoms in the recording layers 14A and 16A is 80% or more, and the ratio of the number of oxygen atoms to the number of constituent atoms in the recording layers 14A and 16A is 63% or more. Incidentally, the ratio of the number of oxygen atoms to the number of constituent atoms in the recording layers 14A and 16A is preferably 73% or less. These recording layers have a refractive index of approximately 2.45, and the relationships between the thickness and the reflectivity of the space portion and the recording mark are shown as the curves S and M in FIG. 1. The reflectivity referred to here is of a single recording layer. However, if the refractive index of the dielectric layers 14B and 14C is close to that of the recording layer 14A, then the reflectivity of the first information layer 14 is close to the reflectivity of a thicker recording layer that has a total thickness of the recording layer 14A and the dielectric layers 14B and 14C shown in the graph of FIG. 1. If the refractive index of the dielectric layers 14B and 14C is lower than that of the recording layer 14A, then the first information layer 14 has a reflectivity of a recording layer thinner than the recording layer that has a total thickness of the recording layer 14A and the dielectric layers 14B and 14C shown in the graph of FIG. 1. In other words, if the refractive index of the dielectric layers 14B and 14C is lower than that of the recording layer 14A, the relationship between the thickness and the reflectivity of the first information layer 14 is shown by a curve obtained by extending the curves shown in FIG. 1 to a larger thickness direction so that the maximum peak and minimum peak of reflectivity are shifted to a larger thickness. The same is true for the second information layer 16. A reflectivity of the second information layer 16 that is estimated from FIG. 1 is almost the same as that measured by a photodetector 24. On the other hand, the reflectivity of the first information layer 14 that is measured by a photodetector 24 is smaller than that estimated from FIG. 1.

If the refractive index of the recording layer 14A and the dielectric layers 14B and 14C is approximately 2.45, the thickness of the first information layer 14 is preferably in the range of approximately 30 nm to 70 nm, and more preferably in the range of approximately 40 nm to 70 nm, which makes the difference in reflectivity between the space portions 20 and the recording marks 22 larger, as can been seen in FIG. 1. The same is true for the second information layer 16, which is thicker than the first information layer 14. Furthermore, for example, if the refractive index of the recording layers 14A and 16A is approximately 2.45, and if the refractive index of the dielectric layers 14B, 14C, 16B, and 16C is a lower value, approximately 1.8, the thickness of the first information layer 14 and the second information layer 16 is preferably in the range of approximately 40 nm to 90 nm, and more preferably in the range of approximately 50 nm to 80 nm, which makes the difference in reflectivity between the space portions 20 and the recording marks 22 larger.

The recording layer 14A of the first information layer 14 and the recording layer 16A of the second information layer 16 each have an extinction coefficient of 0.16 (being not more than 0.35).

The recording layers 14A and 16A are preferably made substantially of bismuth and oxygen, but may further contain one or more different kinds of additional elements. The additional S elements include, for example, Fe (iron), Cu (copper), Mo (molybdenum), Ag (silver), W (tungsten), Ir (iridium), Pt (platinum), Au (gold), Mg (magnesium), Al (aluminum), Si (silicon), Zn (zinc), Ge (germanium), Y (yttrium), Sn (tin), Sb (antimony), V (vanadium), Dy (dysprosium), and Ti (titanium).

The dielectric layers 14B, 14C, 16B, and 16C are made of, for example, a material selected from the group consisting of Ta₂O₃, TiO₂, Y₂O₃, ZnO, ZrO₂, Pr₆O₁₁, Sb₂O₃, Se₂O₃, HfO₂, Nd₂O₃, CeO₂, Fe₂O₃, Sb₂S₃, Bi₂O₃, Al₂O₃, and SiO₂. The refractive index of the dielectric layers 14B, 14C, 16B, and 16C is preferably not less than 1.8, and more preferably not less than 2.0. Among the group of materials, the materials except Al₂O₃ and SiO₂ have a refractive index of no less than 1.9; the materials except Al₂O₃, SiO₂, Y₂O₃ and Se₂O₃ have a refractive index of no less than 2.0; Ta₂O₃, TiO₂, Sb₂O₃, CeO₂, Fe₂O₃, and Bi₂O₃ have a refractive index of 2.3 to 2.5, which is close to the refractive index of the recording layers 14A and 16A. The dielectric layers 14B, 14C, 16B, and 16c are preferably made of common material.

In the second information layer 16, which is placed closer to the incident surface 18 of the laser beam than the first information layer 14, the dielectric layer 16C, which is formed on the side of the recording layer 16A which is closer to the incident surface 18, is preferably thicker than the dielectric layer 16B, which is formed on the side of the recording layer 16A which is further away from the incident surface 18.

A cover layer 28 is formed on the opposite side of the second information layer 16 to the substrate 26. A spacer layer 30 is formed between the first information layer 14 and the second information layer 16.

The substrate 26 has a thickness of approximately 1.1 mm, and a concavo-convex pattern, which makes grooves, is formed on the side of the substrate 26 which faces to the cover layer 28. The term “groove” generally refers to a concave portion used for recording and reproducing of data, but, for convenience in the present specification, also refers to a convex portion, used for the recording and reproducing of data, protruding toward the cover layer 28. In the first exemplary embodiment, the convex portion protruding toward the cover layer 28 is a groove. The substrate 26 is made of, for example, a material selected from the group consisting of polycarbonate, acryl, epoxy, polystyrene, polyethylene, polypropylene, silicone, fluorine, ABS (acrylonitrile butadiene styrene), and urethane resins.

The cover layer 28 has a thickness of, for example, 30 μm to 150 μm. The cover layer 28 is made of, for example, a transparent energy beam-curable resin such as UV-curable acrylic resin and UV-curable epoxy resin. The term “energy beam” is hereinafter used to collectively refer to an electromagnetic wave beam or particle beam, such as an ultra-violet ray or electron beam for curing specific fluid resins. The cover layer 28 may be formed in such a manner that either the fluid resin is applied on the substrate and is then cured by an energy beam, or a transparent film fabricated in advance is stuck on the substrate.

The spacer layer 30 has a thickness in the range of, for example, 10 μm to 90 μm, and concavo-convex patterns which make grooves are formed on both sides of the spacer layer 30, like the substrate 26. The spacer layer 30 is made of, for example, a transparent energy beam-curable resin such as UV-curable acrylic resin and UV-curable epoxy resin, like the cover layer 28.

The first information layer 14 comes in contact with the substrate 26 and is formed in a concavo-convex pattern following the concavo-convex pattern of the substrate 26. Namely, there is no reflective layer between the first information layer 14 and the substrate 26. The second information layer 16 is also formed in a concavo-convex pattern following the concavo-convex pattern of the spacer layer 30.

The optical recording medium 10 is irradiated with a laser beam having a wavelength in the range of 370 nm to 440 nm for the recording and reproducing of data.

The action of the optical recording medium 10 will now be described.

The optical recording medium 10 has a significant difference in reflectivity between the space portions 20 and the recording marks 22, as shown in FIG. 1, since the recording marks 22 that are formed on the first information layer 14 and the second information layer 16 have an increased thickness larger than that of space portions 20 therearound.

Moreover, since the recording layer 14A of the first information layer 14 is thicker than the recording layer 16A of the second information layer 16, the first information layer 14 absorbs an increased amount of energy from the laser beam, thereby making the recording sensitivity of the first information layer 14, which is irradiated with the recording laser beam through the second information layer 16, close to the recording sensitivity of the second information layer 16. Accordingly, good quality recording marks 22 can be formed in both the first information layer 14 and the second information layer 16.

Furthermore, since the recording layer 14A of the first information layer 14 is thicker than the recording layer 16A of the second information layer 16, the reflectivity of the single recording layer 14A is lower than that of the single recording layer 16A. However, since the total thickness of the dielectric layers 14B and 14C of the first information layer 14 is smaller than the total thickness of the dielectric layers 16B and 16C of the second information layer 16, and the entire first information layer 14 is thinner than the entire second information layer 16, the reflectivity of the entire first information layer 14 is higher than that of the entire second information layer 16. Accordingly, the reflectivities of the first information layer 14 and the second information layer 16 as measured by the photodetector 24 can be found to be almost the same.

Since each of the recording layers 14A and 16A contains bismuth (being a constituent element other than carbon, oxygen, nitrogen, hydrogen, and sulfur) in common, the recording layers 14A and 16A can be formed using the same target in a single deposition device, providing a reduction in production costs.

Moreover, the optical recording medium 10 has no reflective layer, and thus this further provides a reduction in production costs. The optical recording medium 10 also gives the first information layer 14 a high reflectivity that is sufficient for the photodetector 24 to detect, without a reflective layer provided between the first information layer 14 and the substrate 26.

A second exemplary embodiment of the present invention will now be described.

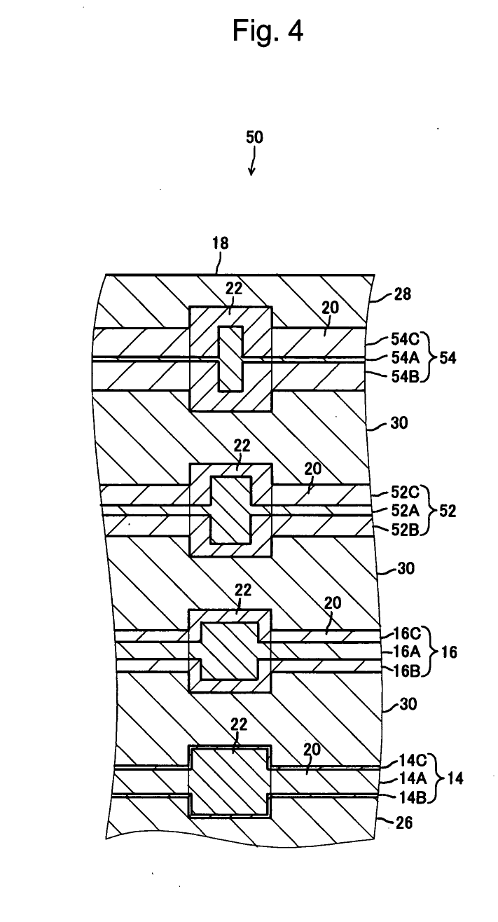

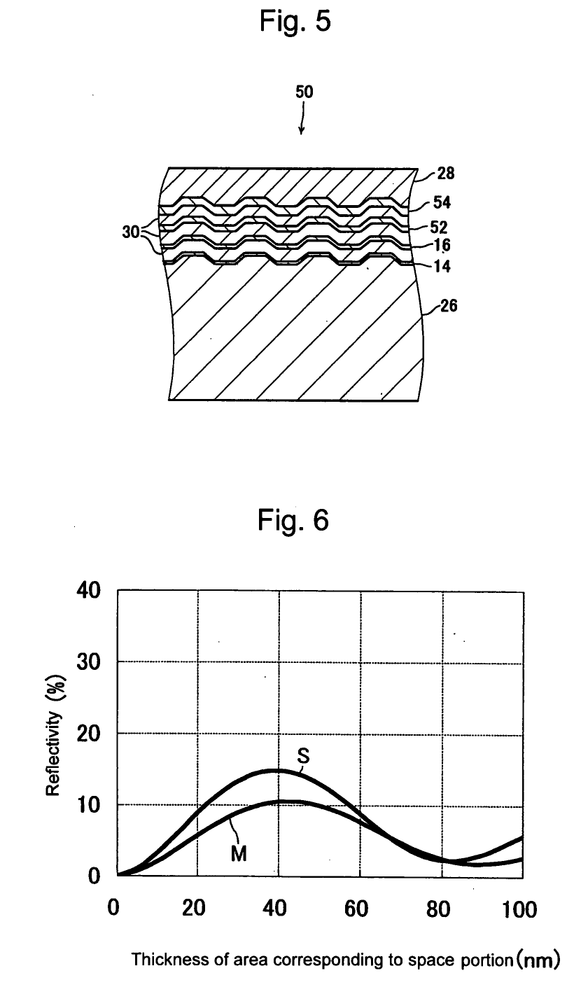

As shown in FIGS. 4 and 5, an optical recording medium 50 according to the second exemplary embodiment differs from the optical recording medium 10 according to the first exemplary embodiment in that a third information layer 52 and a fourth information layer 54 are provided in addition to the first information layer 14 and the second information layer 16. The other components are the same as those of the first exemplary embodiment, and thus denoted by the same reference numerals, and an explanation thereof is omitted as appropriate.

Arranged in order from the substrate 26 to the incident surface 18 are the first information layer 14, the second information layer 16, the third information layer 52, and the fourth information layer 54. The spacer layers 30 are placed between the second information layer 16 and the third information layer 52 and between the third information layer 52 and the fourth information layer 54, respectively. The fourth information layer 54 comes in contact with the cover layer 28.

The third information layer 52 has a recording layer 52A and dielectric layers 52B and 52C that are formed on both sides of the recording layer 52A. The fourth information layer 54 has a recording layer 54A and dielectric layers 54B and 54C that are formed on both sides of the recording layer 54A.

The recording layer 52A of the third information layer 52 and the recording layer 54A of the forth information layer 54 are made of the same materials as the recording layer 14A of the first information layer 14 and the recording layer 16A of the second information layer 16, and contain bismuth and oxygen. In particular, the ratio of the total number of bismuth and oxygen atoms to the number of constituent atoms in the recording layers 52A and 54A is 80% or more, and the ratio of the number of oxygen atoms to the number of constituent atoms in the recording layers 52A and 54A is 63% or more.

The third information layer 52 is thicker than the second information layer 16, and the fourth information layer 54 is thicker than the third information layer 52. In other words, the optical recording medium 50 has a layer structure where the fourth information layer 54, the third information layer 52, the second information layer 16, and the first information layer 14 are arranged in order of decreasing thickness (being the total thickness of the recording layer and the dielectric layers) from the incident surface 18.

Moreover, the optical recording medium 50 has a layer structure where the recording layer 54A of the fourth information layer 54, the recording layer 52A of the third information layer 52, the recording layer 16A of the second information layer 16, and the recording layer 14A of the first information layer 14 are arranged in order of increasing thickness from the incident surface 18.

The optical recording medium 50 has a significant difference in reflectivity between the space portions 20 and the recording marks 22, since the recording marks 22 have an increased thickness larger than the space portions 20 therearound, like the optical recording medium 10.

Since each of the recording layer 14A of the first information layer 14, the recording layer 16A of the second information layer 16, and the recording layer 52A of the third information layer 52 is thicker than the recording layer 54A of the fourth information layer 54, the first information layer 14, the second information layer 16, and the third information layer 52 absorb an increased amount of energy from the laser beam. Accordingly, good quality recording marks 22 can be formed in the first information layer 14, the second information layer 16, and the third information layer 52.

Furthermore, since each of the first information layer 14, the second information layer 16, and the third information layer 52 is thinner than the fourth information layer 54, the reflectivities of the first information layer 14, the second information layer 16, and the third information layer 52 by themselves are higher than that of the fourth information layer 54. Accordingly, the reflectivities of the first information layer 14, the second information layer 16, and the third information layer 52 as measured by the photodetector 24 can be found to be almost the same.

Since each of the recording layers 14A, 16A, 52A, and 54A contains bismuth (being a constituent element other than carbon, oxygen, nitrogen, hydrogen, and sulfur), the recording layers 14A, 16A, 52A, and 54A can be formed using the same target in a single deposition device, providing a reduction in production costs.

Furthermore, the recording layers 14A, 16A, 52A, and 54A have an extinction coefficient of not more than 0.35. Consequently, the second information layer 16, the third information layer 52, and the fourth information layer 54 make it hard to absorb the energy of a laser beam with which the first information layer 14, the second information layer 16, and the third information layer 52 are irradiated. Therefore, the recording layers having the low extinction coefficient make it easy to make the recording powers for forming good quality recording marks in the first information layer 14, the second information layer 16, the third information layer 52, and the fourth information layer 54 close to each other, and to make the reflectivities of these information layers, which are measured by the photodetector 24, close to each other.

In the first and the second exemplary embodiments, each of the recording layers 14A, 16A, 52A, and 54A contains bismuth and oxygen, where the ratio of the total number of bismuth and oxygen atoms to the number of constituent atoms in each recording layer is 80% or more. However, the recording layers 14A, 16A, 52A, and 54A may be made of other materials that allow the formation of the recording marks, having an increased thickness larger than that of a space portion therearound, by an irradiation with a laser beam. For example, the other materials including bismuth, germanium, and nitrogen can be used. Incidentally, in the recording layer that contains bismuth and oxygen, where the ratio of the total number of bismuth and oxygen atoms to the number of total constituent atoms in recording layer is 80% or more, and the ratio of the number of oxygen atoms to the number of the total constituent atoms in the recording layer in is 63% or more, when the recording layer is irradiated with a recording laser beam, O₂ gas is generated within the portion on which a recording mark is to be formed, thereby forming the recording mark having an increased thickness larger than that of a space portion therearound.

In the second exemplary embodiment, the optical recording medium 50 has a layer structure where the recording layer 54A of the fourth information layer 54, the recording layer 52A of the third information layer 52, the recording layer 16A of the second information layer 16, and the recording layer 14A of the first information layer 14 are arranged in order of increasing thickness from the incident surface 18, and where the fourth information layer 54, the third information layer 52, the second information layer 16, and the first information layer 14 are arranged in order of decreasing thickness from the incident surface 18. However, with any two of the information layers, if the recording layer of the lower information layer, which is placed relatively far from the incident surface 18, is thicker than that of the upper information layer, which is placed closer to the incident surface 18 than the lower information layer, and if the lower information layer is thinner than the upper information layer, these two information layers have beneficial effects that make the recording powers for forming good quality recording marks in them close to each other, and make the reflectivity of the lower recording layer close to the reflectivity of the upper recording layer, where these reflectivities are measured by the photodetector, even if the layer structure of the other two information layers is different from that of the second exemplary embodiment.

With reference to FIG. 2 showing the first exemplary embodiment and FIG. 4 showing the second exemplary embodiment, each of the recording marks 22 has an even thickness. However, the shape of the recording mark 22 is not limited to this if at least one S portion of the recording mark 22 has increased thickness larger than that of the space portion 20 therearound. The recording mark 22 may have an uneven thickness which is overall larger than that of the space portion 20 therearound, or may have one portion thicker than that of the space portion 20 therearound and the other portions with the same thickness as the space portions. The recording mark may have, for example, a thick central portion and the other portions may have a thickness that decreases radially from the central portion. In practice, recording marks like this are typically formed. A thickness profile of the recording mark can be observed using a TEM (transmission electron microscope). The recording mark 22 may be formed to protrude significantly toward either one of the substrate 26 and the incident surface 18 with respect to the space portion 20 therearound.

The optical recording medium 10 according to the first exemplary embodiment has two information layers and the optical recording medium 50 according to the second exemplary embodiment has four information layers. The present invention is also applicable to optical recording media having four or more information layers, e.g., eight information layers.

In the first and the second exemplary embodiments, the optical recording media 10 and 50 are one-sided optical recording media, but the present invention is also applicable to double-sided optical recording media.

Furthermore, in the first and the second exemplary S embodiments, the optical recording media 10 and 50 have the cover layer 28 thinner than the substrate 26, however, the present invention is also applicable to optical recording media that have a cover layer and a substrate of the same thickness, like DVDs. In this case, the cover layer and the substrate have almost the same shape. In the specification, the cover layer is defined as the one irradiated with a recording/reproducing laser beam; the substrate is defined as the one not irradiated.

### WORKING EXAMPLE 1

Three samples S₁, S₂, and S₃ of one-sided optical recording media with two information layers, having the same structure as the optical recording medium 10 according to the first exemplary embodiment, were manufactured. The samples S₁, S₂, and S₃ differed from each other in the thicknesses of the dielectric layers 16B and 16C of the second information layer 16, and the specifications other than the dielectric layers 16B and 16C were the same for all these samples.

Specifically, the recording layer 14A of the first information layer 14 and the recording layer 16A of the second information layer 16 were made of bismuth and oxygen, where the ratio of the number of oxygen atoms to the number of constituent atoms in the recording layers 14A and 16A was 71% (being not less than 63%), the ratio of the number of bismuth atoms to the number of constituent atoms in the recording layers was 29%, and there were no additional elements. The deposition conditions for the recording layers 14A and 16A were as follows:
Deposition power (power applied to Bi target): 150 W
Ar gas flow rate: 50 sccm
O₂ gas flow rate: 24 sccm

The recording layer 14A of the first information layer 14, which was thicker than the recording layer 16A of the second information layer 16, had a thickness of approximately 45 nm, which was the same for all the samples. The dielectric layers 14B and 14C of the first information layer 14 had a thickness of approximately 5 nm, which was the same for all the samples. The recording layer 16A of the second information layer 16 had a thickness of approximately 33 nm, which was the same for all the samples.

The dielectric layers 14B and 14C of the first information layer 14 and the dielectric layers 16B and 16C of the second information layer 16 were made of TiO₂. The deposition conditions for the dielectric layers 14B, 14C, 16B, and 16C were as follows:
Deposition power (power applied to TiO₂ target) : 800 W
Ar gas flow rate: 50 sccm

The dielectric layers 16B of the second information layers 16 of the three samples S₁, S₂, and S₃ had different thicknesses, being 20 nm, 15 nm, and 10 nm, respectively. On the other hand, the dielectric layers 16C of the second information layers 16 of the samples S₁, S₂, and S₃ had different thicknesses, being 10 nm, 15 nm, and 20 nm, respectively. The total thickness of the dielectric layers 16B and 16C was 30 nm, which was the same for all the samples S₁, S₂, and S₃.

The reflectivities of the space portion 20, recording sensitivity, and 8T C/N ratio of the first information layer 14 and the second information layer 16 were measured for each of the samples S₁, S₂, and S₃. The measurement results are shown together with the structure of the first information layer 14 and the second information layer 16 for each of the samples S₁, S₂, and S₃ in Table 1.

A reproducing laser beam with the same power was used to measure the reflectivities of the first information layer 14 and the second information layer 16. The reflectivities shown in Table 1 were measured by the photodetector 24.

The recording sensitivity was measured in the following manner. Each sample was first irradiated with laser beams of various power levels to form recording marks 22. Jitter of each recording mark 22 was then measured by a recording/reproducing device. Since the power of the laser beam that had given the lowest jitter to the recording mark 22 was suitable for the optical recording medium, that power level was defined as the recording sensitivity. The power of the laser beam is defined as an electric power to which the intensity of the laser beam on the incident surface 18 is converted. The lower the power of the laser beam representing recording sensitivity is, the easier the recording mark is formed and the greater the sensitivity is.

TABLE 1

| | | | | | | Recording | 8T C/N |
|---|---|---|---|---|---|---|---|
| | Information layer | | Thickness | total | Reflectivity | sensitivity | ratio |
| Sample | structure | | (nm) | thickness | (%) | (mW) | (dB) |
| S₁ | Second | Dielectric layer | 10 | 63 | 7.5 | 7.0 | 58 |
| | information | Recording layer | 33 | | | | |
| | layer | Dielectric layer | 20 | | | | |
| | First | Dielectric layer | 5 | 55 | 6.4 | 5.5 | 57 |
| | information | Recording layer | 45 | | | | |
| | layer | Dielectric layer | 5 | | | | |
| S₂ | Second | Dielectric layer | 15 | 63 | 5.8 | 6.5 | 58 |
| | information | Recording layer | 33 | | | | |
| | layer | Dielectric layer | 15 | | | | |
| | First | Dielectric layer | 5 | 55 | 6.5 | 5.5 | 58 |
| | information | Recording layer | 45 | | | | |
| | layer | Dielectric layer | 5 | | | | |
| S₃ | Second | Dielectric layer | 20 | 63 | 5.1 | 5.5 | 58 |
| | information | Recording layer | 33 | | | | |
| | layer | Dielectric layer | 10 | | | | |
| | First | Dielectric layer | 5 | 55 | 6.3 | 5.7 | 58 |
| | information | Recording layer | 45 | | | | |
| | layer | Dielectric layer | 5 | | | | |
| S₄ | Second | Dielectric layer | 20 | 61 | 5.7 | 6.3 | 58 |
| | information | Recording layer | 31 | | | | |
| | layer | Dielectric layer | 10 | | | | |
| | First | Dielectric layer | 5 | 55 | 6.3 | 5.7 | 58 |
| | information | Recording layer | 45 | | | | |
| | layer | Dielectric layer | 5 | | | | |

### WORKING EXAMPLE 2

A sample S₄ having a recording layer 16A of second information layer 16 of 31 nm, being thinner than that of the sample S₃ in Working Example 1 by 2 nm, was manufactured. The other specifications of the sample S₄ were the same as those of the sample S₃.

The reflectivities, recording sensitivity, and 8T C/N ratio of the first information layer 14 and the second information layer 16 were measured for the sample S₄ in the same manner as Working Example 1. The measurement results are shown together with the structure of the first information layer 14 and the second information layer 16 for the sample S₄ in Table 1.

### WORKING EXAMPLE 3

Two samples S₅ and S₆ of one-sided optical recording media with four information layers, having the same structure as the optical recording medium 50 according to the second exemplary embodiment, were manufactured. The samples S₅ and S₆ differed from each other only in the third information layer 52 and the fourth information layer 54, and the specifications other than the information layers 52 and 54 were the same for the samples S₅ and S₆. The composition and deposition conditions of the recording layers 14A, 16A, 52A, and 54A of the samples S₅ and S₆ were the same as those of the recording layers 14A and 16A of the samples S₁, S₂, and S₃ in Working Example 1. The composition and deposition conditions of the dielectric layers 14B, 14C, 16B, 16C, 52B, 52C, 54B, and 54C of the samples S₅ and S₆ were also the same as those of the dielectric layers 14B, 14C, 16B, and 16C of the samples S₁, S₂, and S₃ in Working Example 1.

The reflectivities, recording sensitivity, and 8T C/N ratio of the first information layer 14, the second information layer 16, the third information layer 52, and the fourth information layer 54 were measured for each of the samples S₅ and S₆. The measurement results are shown together with the structure of the first information layer 14, the second information layer 16, the third information layer 52, and the fourth information layer 54 for the samples S₅ and S₆ in Table 2.

TABLE 2

| | | | | | | Recording | 8T C/N |
|---|---|---|---|---|---|---|---|
| | Information layer | | Thickness | total | Reflectivity | sensitivity | ratio |
| Sample | structure | | (nm) | thickness | (%) | (mW) | (dB) |
| S₅ | Fourth | Dielectric layer | 22 | 65 | 4.4 | 8.0 | 59 |
| | information | Recording layer | 21 | | | | |
| | layer | Dielectric layer | 22 | | | | |
| | Third | Dielectric layer | 18 | 62 | 4.0 | 8.5 | 60 |
| | information | Recording layer | 26 | | | | |
| | layer | Dielectric layer | 18 | | | | |
| | Second | Dielectric layer | 13 | 56 | 4.9 | 9.6 | 59 |
| | information | Recording layer | 30 | | | | |
| | layer | Dielectric layer | 13 | | | | |
| | First | Dielectric layer | 5 | 50 | 4.1 | 10.5 | 57 |
| | information | Recording layer | 40 | | | | |
| | layer | Dielectric layer | 5 | | | | |
| S₆ | Fourth | Dielectric layer | 25 | 64 | 4.6 | 8.0 | 59 |
| | information | Recording layer | 20 | | | | |
| | layer | Dielectric layer | 19 | | | | |
| | Third | Dielectric layer | 21 | 60 | 4.2 | 8.5 | 59 |
| | information | Recording layer | 24 | | | | |
| | layer | Dielectric layer | 15 | | | | |
| | Second | Dielectric layer | 13 | 56 | 4.8 | 9.6 | 59 |
| | information | Recording layer | 30 | | | | |
| | layer | Dielectric layer | 13 | | | | |
| | First | Dielectric layer | 5 | 50 | 4.2 | 10.5 | 57 |
| | information | Recording layer | 40 | | | | |
| | layer | Dielectric layer | 5 | | | | |

### WORKING EXAMPLE 4

A fundamental information layer having the same structure as the second information layer 16 of the sample S₂ in Working Example 1 was manufactured. Furthermore, three information layers having dielectric layers with different compositions and reflectivities from those of the dielectric layers of the fundamental information layer were manufactured. The dielectric layers of the three information layers had thicknesses which provided a reflectivity, recording sensitivity, and 8T C/N ratio which were close to those of the fundamental information layer. The measurement results of these four information layers, reflectivity, recording sensitivity, and 8T C/N ratio are shown together with their structures in Table 3.

TABLE 3

| Dielectric | | | | | | | | | |
|---|---|---|---|---|---|---|---|---|---|
| layer | | | Refractive | | | | | | |
| composition | | | index of | | | | | Recording | 8T C/N |
| (at %) | | | dielectric | | Thickness | total | Reflectivity | sensitivity | ratio |
| Si | Ti | O | layer | | (nm) | thickness | (%) | (mW) | (dB) |
| 23 | 10 | 67 | 1.8 | Dielectric layer | 29 | 91 | 5.9 | 6.0 | 59 |
| | | | | Recording layer | 33 | | | | |
| | | | | Dielectric layer | 29 | | | | |
| 17 | 17 | 66 | 2.0 | Dielectric layer | 22 | 77 | 6.1 | 5.7 | 58 |
| | | | | Recording layer | 33 | | | | |
| | | | | Dielectric layer | 22 | | | | |
| 8 | 25 | 67 | 2.2 | Dielectric layer | 18 | 69 | 6.0 | 5.7 | 58 |
| | | | | Recording layer | 33 | | | | |
| | | | | Dielectric layer | 18 | | | | |
| 0 | 33 | 67 | 2.5 | Dielectric layer | 15 | 63 | 5.8 | 5.5 | 58 |
| | | | | Recording layer | 33 | | | | |
| | | | | Dielectric layer | 15 | | | | |

### COMPARATIVE EXAMPLE

A sample S₇ of one-sided optical recording medium having the second information layer with only recording layer and without a dielectric layer on contrast with Working Example 1, was manufactured. The other specifications of the sample S₇ were the same as those of the samples S₁, S₂, and S₃ in Working Example 1.

Specifically, the recording layers of the sample S₇ were made of bismuth and oxygen like the samples S₁, S₂, and S₃, where the ratio of the number of oxygen atoms to the number of constituent atoms in the recording layers was 68% (being not less than 63%), the ratio of the number of bismuth atoms to the number of constituent atoms was 32%, and there are no additional elements. The deposition conditions for the recording layers were as follows:
Deposition power (power applied to Bi target): 200 W
Ar gas flow rate: 50 sccm

O₂ gas flow rate: 5 sccm

The reflectivities of portions on which recording marks were not formed, recording sensitivity, and 8T C/N ratio of the first and second information layers were measured for the sample S₇. The measurement results are shown together with the structure of the first and the second information layers of the sample S₇ in Table 4.

TABLE 4

| | | | | | | Recording | 8T C/N |
|---|---|---|---|---|---|---|---|
| | Information layer | | Thickness | total | Reflectivity | sensitivity | ratio |
| Sample | structure | | (nm) | thickness | (%) | (mW) | (dB) |
| S₇ | Second | Dielectric layer | — | 33 | 9.8 | 7.0 | 46 |
| | information | Recording layer | 33 | | | | |
| | layer | Dielectric layer | — | | | | |
| | First | Dielectric layer | 5 | 55 | 6.5 | 5.0 | 58 |
| | information | Recording layer | 45 | | | | |
| | layer | Dielectric layer | 5 | | | | |

As shown in Tables 1 and 2, each of the samples S₁ to S₆ in Working Examples 1 to 3 had good quality information layers with an 8T C/N ratio of not less than 55 dB. In other words, each of the samples S₁ to S₆ in Working Examples 1 to 3 had good quality recording marks 22 formed on each recording layer thereof.

Furthermore, the reflectivities of the information layers of the samples S₁ to S₆ were measured to be close to each other by the photodetector 24. Specifically, the percentage of the difference between the maximum reflectivity and the minimum reflectivity to the minimum reflectivity was less than 24%.

Also, the recording sensitivities of the information layers of the samples S₁ to S₆ were measured to be close to each other by the photodetector 24. Specifically, the percentage of the difference between the maximum recording sensitivity and the minimum recording sensitivity to the minimum recording sensitivity was less than 32%.

As a result, the samples S₁ to S₆ had recording layers having reflectivities close to each other and recording sensitivities close to each other, and good quality recording marks 22 were formed therein. Furthermore, since each of the samples S₁ to S₆ was made of bismuth and oxygen, a single deposition device was used to deposit s the recording layers, and thus had the advantage of providing a reduction in production costs.

The sample S₄, in which the dielectric layer 16C placed on the side close to the cover layer 28 was thicker than the dielectric layer 16B placed on the side close to the substrate 26, had the recording layer 16A thinner than that of the sample S₂, in which the dielectric layers 16B and 16C had the same thickness. Despite this, the second information layers 16 of the sample S₂ and S₄ had almost the same reflectivity. This showed that the cover layer side dielectric layer being thicker than the substrate side dielectric layer gave sufficient reflectivity to the information layer even with a thin recording layer between the dielectric layers. In other words, this dielectric layer structure allows a thinner recording layer to be placed between the dielectric layers, thereby further improving productivity and reducing production costs.

As shown in Table 3, the information layer having dielectric layers with a refractive index of 1.8 or more had good reflectivity, recording sensitivity, and a good 8T C/N ratio. The dielectric layers with a higher refractive index allowed a thinner dielectric layer without reducing the reflectivity, recording sensitivity, and 8T C/N ratio. Accordingly, the thinner dielectric layers allow further improvements in productivity and provide a reduction in production costs.

By contrast, with the reflectivities measured by the photodetector 24, the sample S₇ in Comparative example had a large difference in reflectivity between the recording layers. Specifically, the percentage of the difference between the maximum reflectivity and the minimum reflectivity to the minimum reflectivity was as large as approximately 50%. The sample S₇ also had a large difference in recording sensitivity between the information layers. Specifically, the percentage of the difference between the maximum recording sensitivity and the minimum recording sensitivity to the minimum recording sensitivity was as large as approximately 40%. The first information layer had a recording sensitivity of not less than 55 dB, but the second information layer had a recording sensitivity of less than 50 dB, which was not good.

The present invention is applicable to optical recording media having a plurality of recording layers.

What is claimed is:

1. An optical recording medium comprising a plurality of information layers and no reflective layer on at least one side, the information layers in which a recording mark, having an increased thickness larger than that of a space portion therearound, is formed by an irradiation with a laser beam, at least two of the information layers each having a recording layer and a dielectric layer formed on at least one side of the recording layer, one of these information layers, which is placed relatively far from an incident surface of a laser beam, having a recording layer that is thicker than that of the other of the information layers, which is placed relatively closer to the incident surface than the one information layer, the one information layer having a dielectric layer that is thinner than that of the other information layer, wherein a total thickness of the recording layer and the dielectric layer of the one information layer is smaller than that of the other information layer.

2. The optical recording medium according to claim 1, wherein the recording layers of the plurality of information layers each contain a constituent element other than carbon, oxygen, nitrogen, hydrogen, and sulfur, and constituent elements of the recording layers, at least other than carbon, oxygen, nitrogen, hydrogen, and sulfur, are common.

3. An optical recording medium comprising a plurality of information layers on at least one side, information layers in which a recording mark, having an increased thickness larger than that of a space portion therearound, is formed by an irradiation with a laser beam, at least two of the information layers each having a recording layer and a dielectric layer formed on at least one side of the recording layer, the recording layers each containing a constituent element other than carbon, oxygen, nitrogen, hydrogen, and sulfur, and constituent elements of the recording layers, at least other than carbon, oxygen, nitrogen, hydrogen, and sulfur, are common, one of the information layers, which is placed relatively far from an incident surface of a laser beam, has a recording layer that is thicker than that of the other of the information layers, which is placed relatively closer to the incident surface than the one information layer, the one information layer having a dielectric layer that is thinner than that of the is other information layer, wherein a total thickness of the recording layer and the dielectric layer of the one information layer is smaller than that of the other information layer.

4. The optical recording medium according to claim 3, wherein one of the information layers that is placed farthest from the incident surface comprises only the recording layer and the dielectric layer, and is formed in contact with a substrate.

5. The optical recording medium according to claim 1, wherein the recording layers each contain bismuth and oxygen, a ratio of a total number of bismuth and oxygen atoms to a number of constituent atoms in the recording layer is 80% or more, and a ratio of a number of oxygen atoms to the number of constituent atoms in the recording layer is 63% or more.

6. The optical recording medium according to claim 2, wherein the recording layers each contain bismuth and oxygen, a ratio of a total number of bismuth and oxygen atoms to a number of constituent atoms in the recording layer is 80% or more, and a ratio of a number of oxygen atoms to the number of constituent atoms in the recording layer is 63% or more.

7. The optical recording medium according to claim 3, wherein the recording layers each contain bismuth and oxygen, a ratio of a total number of bismuth and oxygen atoms to a number of constituent atoms in the recording layer is 80% or more, and a ratio of a number of oxygen atoms to the number of constituent atoms in the recording layer is 63% or more.

8. The optical recording medium according to claim 4, wherein the recording layers each contain bismuth and oxygen, a ratio of a total number of bismuth and oxygen atoms to a number of constituent atoms in the recording layer is 80% or more, and a ratio of a number of oxygen atoms to the number of constituent atoms in the recording layer is 63% or more.
